(19) United States
(12) Patent Application Publication
(10) Pub. No.: US 2025/0377952 A1
(43) Pub. Date: Dec. 11, 2025

(54) WORKLOAD SLA SATISFACTION SYSTEM

(71) Applicant: Dell Products L.P., Round Rock, TX (US)

(72) Inventors: Douglas Lang Farley, Round Rock, TX (US); Ethan A. Kaley, North Kingstown, RI (US); Joshua Gill, Apex, NC (US)

(21) Appl. No.: 18/737,312

(22) Filed: Jun. 7, 2024

(51) Int. Cl. G06F 9/50

(52) U.S. Cl. CPC G06F 9/505

(57) ABSTRACT

A workload Service Level Agreement (SLA) satisfaction system includes a resource management system that is coupled to a client device and each of a plurality of resource devices. The resource management system receives a workload intent that identifies workload capabilities of a first workload, generates a Directed Acyclic Graph (DAG) that maps the workload capabilities to a first subset of the plurality of resource devices that are configured to provide the workload capabilities and to Service Level Agreement (SLA) monitoring functionality, configures the first subset of the plurality of resource devices to perform the first workload and report SLA information according to the SLA monitoring functionality, and configures an SLA monitoring subsystem based on the SLA monitoring functionality to receive the SLA information during performance of the first workload by the first subset of the plurality of resource devices, and perform a management operation based on the SLA information.

### BACKGROUND

The present disclosure relates generally to information handling systems, and more particularly to satisfying Service Level Agreements (SLAs) for workloads performed using information handling systems.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems such as, for example, server devices (e.g., “Bare Metal Servers (BMSs)) and/or other computing devices known in the art, are often utilized to perform workloads. For example, a user or administrator may provide a request to perform a workload, a server device may be selected for performing the workload, and the resources of that server device may then be subsequently used to perform the workload for which that server device was selected. However, the conventional provisioning of any workload is often limited by a static allocation of resources in its server device, and the size of server devices often prevents optimization of workload performance (e.g., the fixed and limited resources available in a BMS typically requires a “best fit” allocation of resources in that server device to provide any particular workload). As such, conventional workload provisioning systems can experience issues with satisfying Service Level Agreements (SLAs) for workloads (particularly when a server device is utilized to perform multiple workloads that require the divvying up its resources using the static allocations described above), and often results in the inefficient use of the resources in server devices in performing workloads.

Accordingly, it would be desirable to provide a workload provisioning system that addresses the issues discussed above.

### SUMMARY

According to one embodiment, an Information Handling System (IHS) includes a processing system; and a memory system that is coupled to the processing system and that includes instructions that, when executed by the processing system, cause the processing system to provide a resource management engine that is configured to: receive a workload intent that identifies workload capabilities of a first workload; generate a Directed Acyclic Graph (DAG) that maps the workload capabilities to a first subset of a plurality of resource devices that are coupled to the processing system and configured to provide the workload capabilities, and to Service Level Agreement (SLA) monitoring functionality; configure the first subset of the plurality of resource devices to perform the first workload and report SLA information according to the SLA monitoring functionality; and configure, based on the SLA monitoring functionality, an SLA monitoring subsystem that is configured, during performance of the first workload by the first subset of the plurality of resource devices, to receive the SLA information and perform a management operation based on the SLA information.

### BRIEF DESCRIPTION OF THE DRAWINGS

FIG. 1 is a schematic view illustrating an embodiment of an Information Handling System (IHS).

FIG. 2 is a schematic view illustrating an embodiment of an LCS provisioning system.

FIG. 3 is a schematic view illustrating an embodiment of an LCS provisioning subsystem that may be included in the LCS provisioning system of FIG. 2.

FIG. 4 is a schematic view illustrating an embodiment of a resource system that may be included in the LCS provisioning subsystem of FIG. 3.

FIG. 5 is a schematic view illustrating an embodiment of the provisioning of an LCS using the LCS provisioning system of FIG. 2.

FIG. 6 is a schematic view illustrating an embodiment of the provisioning of an LCS using the LCS provisioning system of FIG. 2.

FIG. 7 is a schematic view illustrating an embodiment of the workload SLA satisfaction system provided according to the teachings of the present disclosure.

FIG. 8 is a flow chart illustrating an embodiment of a method for satisfying an SLA for a workload.

FIG. 9 is a schematic view illustrating an embodiment of the workload SLA satisfaction system of FIG. 7 operating during the method of FIG. 8.

FIG. 10A is a schematic view illustrating an embodiment of the workload SLA satisfaction system of FIG. 7 operating during the method of FIG. 8.

FIG. 10B is a graph view illustrating an embodiment of a DAG generated during the method of FIG. 8.

FIG. 11 is a schematic view illustrating an embodiment of the workload SLA satisfaction system of FIG. 7 operating during the method of FIG. 8.

FIG. 12 is a schematic view illustrating an embodiment of the workload SLA satisfaction system of FIG. 7 operating during the method of FIG. 8.

FIG. 13 is a flow chart illustrating an embodiment of a method for satisfying an SLA for a workload.

FIG. 14A is a schematic view illustrating an embodiment of the workload SLA satisfaction system of FIG. 7 operating during the method of FIG. 8.

FIG. 14B is a schematic view illustrating an embodiment of the workload SLA satisfaction system of FIG. 7 operating during the method of FIG. 8.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

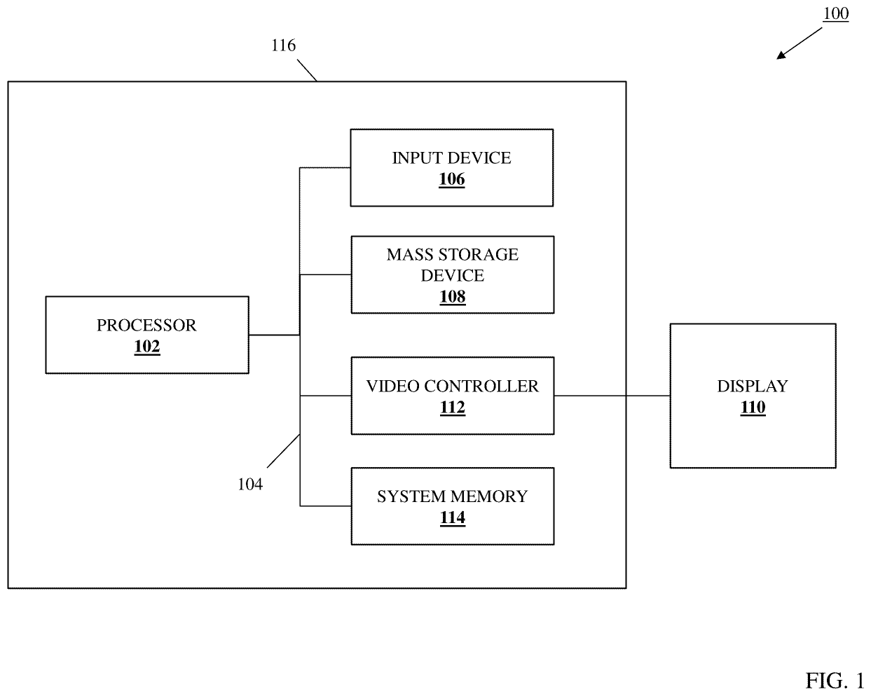

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety of other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

As discussed in further detail below, the workload SLA satisfaction systems and methods of the present disclosure may be utilized with Logically Composed Systems (LCSs), which one of skill in the art in possession of the present disclosure will recognize may be provided to users as part of an intent-based, as-a-Service delivery platform that enables multi-cloud computing while keeping the corresponding infrastructure that is utilized to do so “invisible” to the user in order to, for example, simplify the user/workload performance experience. As such, the LCSs discussed herein enable relatively rapid utilization of technology from a relatively broader resource pool, optimize the allocation of resources to workloads to provide improved scalability and efficiency, enable seamless introduction of new technologies and value-add services, and/or provide a variety of other benefits that would be apparent to one of skill in the art in possession of the present disclosure.

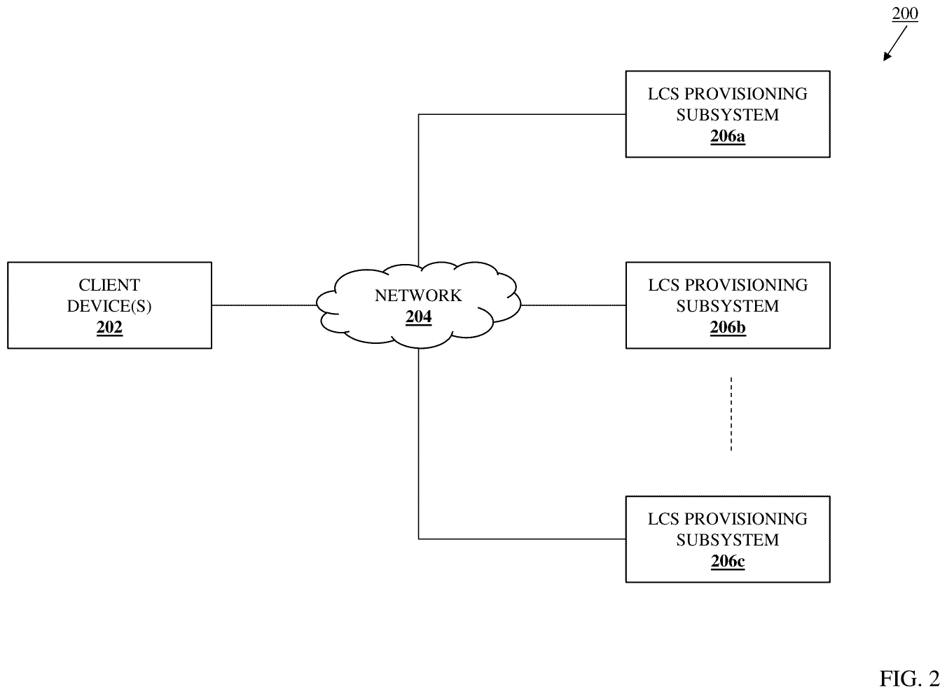

With reference to FIG. 2, an embodiment of a Logically Composed System (LCS) provisioning system 200 is illustrated that may be utilized with the workload SLA satisfaction systems and methods of the present disclosure. In the illustrated embodiment, the LCS provisioning system 200 includes one or more client devices 202. In an embodiment, any or all of the client devices may be provided by the IHS 100 discussed above with reference to FIG. 1 and/or may include some or all of the components of the IHS 100, and in specific examples may be provided by desktop computing devices, laptop/notebook computing devices, tablet computing devices, mobile phones, and/or any other computing device known in the art. However, while illustrated and discussed as being provided by specific computing devices, one of skill in the art in possession of the present disclosure will recognize that the functionality of the client device(s) 202 discussed below may be provided by other computing devices that are configured to operate similarly as the client device(s) 202 discussed below, and that one of skill in the art in possession of the present disclosure would recognize as utilizing the LCSs described herein. As illustrated, the client device(s) 202 may be coupled to a network 204 that may be provided by a Local Area Network (LAN), the Internet, combinations thereof, and/or any of network that would be apparent to one of skill in the art in possession of the present disclosure.

As also illustrated in FIG. 2, a plurality of LCS provisioning subsystems 206a, 206b, and up to 206c are coupled to the network 204 such that any or all of those LCS provisioning subsystems 206a-206c may provide LCSs to the client device(s) 202 as discussed in further detail below. In an embodiment, any or all of the LCS provisioning subsystems 206a-206c may include one or more of the IHS 100 discussed above with reference to FIG. 1 and/or may include some or all of the components of the IHS 100. For example, in some of the specific examples provided below, each of the LCS provisioning subsystems 206a-206c may be provided by a respective datacenter or other computing device/computing component location (e.g., a respective one of the “clouds” that enables the “multi-cloud” computing discussed above) in which the components of that LCS provisioning subsystem are included. However, while a specific configuration of the LCS provisioning system 200 (e.g., including multiple LCS provisioning subsystems 206a-206c) is illustrated and described, one of skill in the art in possession of the present disclosure will recognize that other configurations of the LCS provisioning system 200 (e.g., a single LCS provisioning subsystem, LCS provisioning subsystems that span multiple datacenters/computing device/computing component locations, etc.) will fall within the scope of the present disclosure as well.

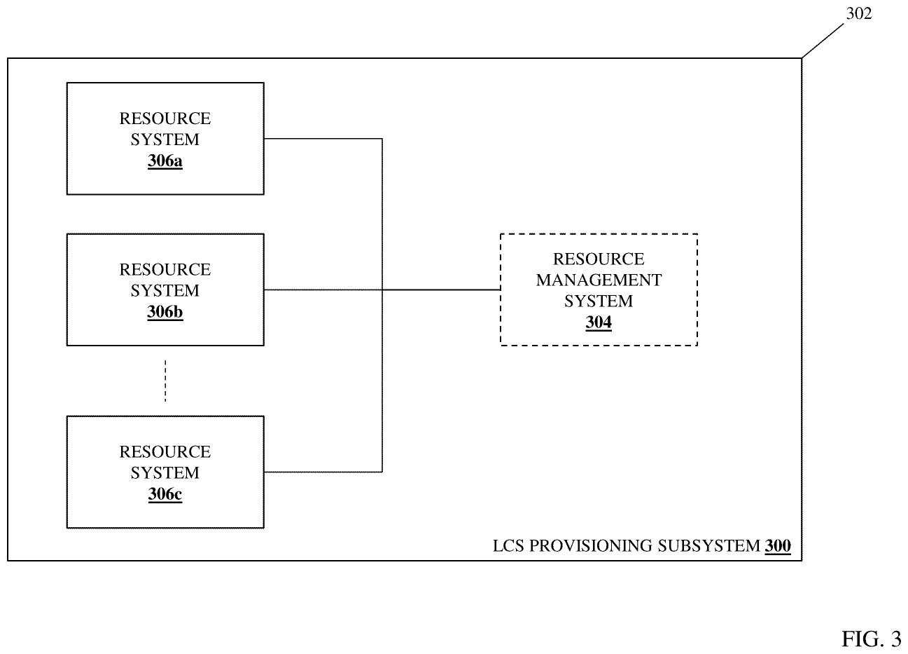

With reference to FIG. 3, an embodiment of an LCS provisioning subsystem 300 is illustrated that may provide any of the LCS provisioning subsystems 206a-206c discussed above with reference to FIG. 2. As such, the LCS provisioning subsystem 300 may include one or more of the IHS 100 discussed above with reference to FIG. 1 and/or may include some or all of the components of the IHS 100, and in the specific examples provided below may be provided by a datacenter or other computing device/computing component location in which the components of the LCS provisioning subsystem 300 are included. However, while a specific configuration of the LCS provisioning subsystem 300 is illustrated and described, one of skill in the art in possession of the present disclosure will recognize that other configurations of the LCS provisioning subsystem 300 will fall within the scope of the present disclosure as well.

In the illustrated embodiment, the LCS provisioning subsystem 300 is provided in a datacenter 302, and includes a resource management system 304 coupled to a plurality of resource systems 306a, 306b, and up to 306c. In an embodiment, any of the resource management system 304 and the resource systems 306a-306c may be provided by the IHS 100 discussed above with reference to FIG. 1 and/or may include some or all of the components of the IHS 100. In the specific embodiments provided below, each of the resource management system 304 and the resource systems 306a-306c may include a System Control Processor (SCP) device that may be conceptualized as an “enhanced” SmartNIC device that may be configured to perform functionality that is not available in conventional SmartNIC devices such as, for example, the resource management functionality, LCS provisioning functionality, and/or other SCP functionality described herein.

In an embodiment, any of the resource systems 306a-306c may include any of the resources described below coupled to an SCP device that is configured to facilitate management of those resources by the resource management system 304. Furthermore, the SCP device included in the resource management system 304 may provide an SCP Manager (SCPM) subsystem that is configured to manage the SCP devices in the resource systems 306a-306c, and that performs the functionality of the resource management system 304 described below. In some examples, the resource management system 304 may be provided by a “stand-alone” system (e.g., that is provided in a separate chassis from each of the resource systems 306a-306c), and the SCPM subsystem discussed below may be provided by a dedicated SCP device, processing/memory resources, and/or other components in that resource management system 304. However, in other embodiments, the resource management system 304 may be provided by one of the resource systems 306a-306c (e.g., it may be provided in a chassis of one of the resource systems 306a-306c), and the SCPM subsystem may be provided by an SCP device, processing/memory resources, and/or any other any other components om that resource system.

As such, the resource management system 304 is illustrated with dashed lines in FIG. 3 to indicate that it may be a stand-alone system in some embodiments, or may be provided by one of the resource systems 306a-306c in other embodiments. Furthermore, one of skill in the art in possession of the present disclosure will appreciate how SCP devices in the resource systems 306a-306c may operate to “elect” or otherwise select one or more of those SCP devices to operate as the SCPM subsystem that provides the resource management system 304 described below. However, while a specific configuration of the LCS provisioning subsystem 300 is illustrated and described, one of skill in the art in possession of the present disclosure will recognize that other configurations of the LCS provisioning subsystem 300 will fall within the scope of the present disclosure as well.

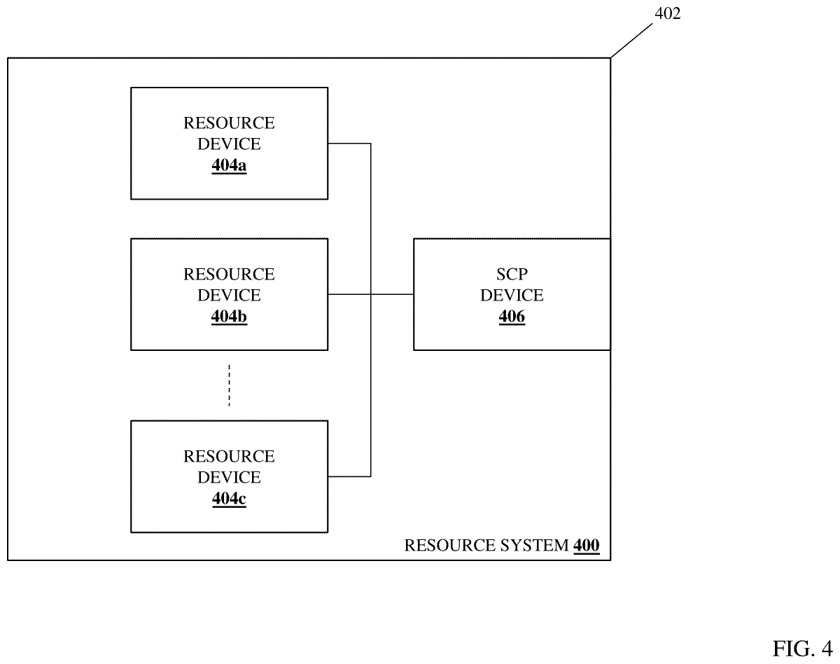

With reference to FIG. 4, an embodiment of a resource system 400 is illustrated that may provide any or all of the resource systems 306a-306c discussed above with reference to FIG. 3. In an embodiment, the resource system 400 may be provided by the IHS 100 discussed above with reference to FIG. 1 and/or may include some or all of the components of the IHS 100. In the illustrated embodiment, the resource system 400 includes a chassis 402 that houses the components of the resource system 400, only some of which are illustrated and discussed below. In the illustrated embodiment, the chassis 402 houses an SCP device 406. In an embodiment, the SCP device 406 may include a processing system (not illustrated, but which may include the processor 102 discussed above with reference to FIG. 1) and a memory system (not illustrated, but which may include the memory 114 discussed above with reference to FIG. 1) that is coupled to the processing system and that includes instructions that, when executed by the processing system, cause the processing system to provide an SCP engine that is configured to perform the functionality of the SCP engines and/or SCP devices discussed below. Furthermore, the SCP device 406 may also include any of a variety of SCP components (e.g., hardware/software) that are configured to enable any of the SCP functionality described below.

In the illustrated embodiment, the chassis 402 also houses a plurality of resource devices 404a, 404b, and up to 404c, each of which is coupled to the SCP device 406. For example, the resource devices 404a-404c may include processing systems (e.g., first type processing systems such as those available from INTEL® Corporation of Santa Clara, California, United States, second type processing systems such as those available from ADVANCED MICRO DEVICES (AMD)® Inc. of Santa Clara, California, United States, Advanced Reduced Instruction Set Computer (RISC) Machine (ARM) devices, Graphics Processing Unit (GPU) devices, Tensor Processing Unit (TPU) devices, Field Programmable Gate Array (FPGA) devices, accelerator devices, etc.); memory systems (e.g., Persistence MEMory (PMEM) devices (e.g., solid state byte-addressable memory devices that reside on a memory bus), etc.); storage devices (e.g., Non-Volatile Memory express over Fabric (NVMe-oF) storage devices, Just a Bunch Of Flash (JBOF) devices, etc.); networking devices (e.g., Network Interface Controller (NIC) devices, etc.); and/or any other devices that one of skill in the art in possession of the present disclosure would recognize as enabling the functionality described as being enabled by the resource devices 404a-404c discussed below. As such, the resource devices 404a-404c in the resource systems 306a-306c/400 may be considered a “pool” of resources that are available to the resource management system 304 for use in composing LCSs.

To provide a specific example, the SCP devices described herein may operate to provide a Root-of-Trust (RoT) for their corresponding resource devices/systems, to provide an intent management engine for managing the workload intents discussed below, to perform telemetry generation and/or reporting operations for their corresponding resource devices/systems, to perform identity operations for their corresponding resource devices/systems, provide an image boot engine (e.g., an operating system image boot engine) for LCSs composed using a processing system/memory system controlled by that SCP device, and/or perform any other operations that one of skill in the art in possession of the present disclosure would recognize as providing the functionality described below. Further, as discussed below, the SCP devices describe herein may include Software-Defined Storage (SDS) subsystems, inference subsystems, data protection subsystems, Software-Defined Networking (SDN) subsystems, trust subsystems, data management subsystems, compression subsystems, encryption subsystems, and/or any other hardware/software described herein that may be allocated to an LCS that is composed using the resource devices/systems controlled by that SCP device. However, while an SCP device is illustrated and described as performing the functionality discussed below, one of skill in the art in possession of the present disclosure will appreciate that functionality described herein may be enabled on other devices while remaining within the scope of the present disclosure as well.

Thus, the resource system 400 may include the chassis 402 including the SCP device 406 connected to any combinations of resource devices. To provide a specific embodiment, the resource system 400 may provide a “Bare Metal Server” that one of skill in the art in possession of the present disclosure will recognize may be a physical server system that provides dedicated server hosting to a single tenant, and thus may include the chassis 402 housing a processing system and a memory system, the SCP device 406, as well as any other resource devices that would be apparent to one of skill in the art in possession of the present disclosure. However, in other specific embodiments, the resource system 400 may include the chassis 402 housing the SCP device 406 coupled to particular resource devices 404a-404c. For example, the chassis 402 of the resource system 400 may house a plurality of processing systems (i.e., the resource devices 404a-404c) coupled to the SCP device 406. In another example, the chassis 402 of the resource system 400 may house a plurality of memory systems (i.e., the resource devices 404a-404c) coupled to the SCP device 406. In another example, the chassis 402 of the resource system 400 may house a plurality of storage devices (i.e., the resource devices 404a-404c) coupled to the SCP device 406. In another example, the chassis 402 of the resource system 400 may house a plurality of networking devices (i.e., the resource devices 404a-404c) coupled to the SCP device 406. However, one of skill in the art in possession of the present disclosure will appreciate that the chassis 402 of the resource system 400 housing a combination of any of the resource devices discussed above will fall within the scope of the present disclosure as well.

As discussed in further detail below, the SCP device 406 in the resource system 400 will operate with the resource management system 304 (e.g., an SCPM subsystem) to allocate any of its resources devices 404a-404c for use in a providing an LCS. Furthermore, the SCP device 406 in the resource system 400 may also operate to allocate SCP hardware and/or perform functionality, which may not be available in a resource device that it has allocated for use in providing an LCS, in order to provide any of a variety of functionality for the LCS. For example, the SCP engine and/or other hardware/software in the SCP device 406 may be configured to perform encryption functionality, compression functionality, and/or other storage functionality known in the art, and thus if that SCP device 406 allocates storage device(s) (which may be included in the resource devices it controls) for use in a providing an LCS, that SCP device 406 may also utilize its own SCP hardware and/or software to perform that encryption functionality, compression functionality, and/or other storage functionality as needed for the LCS as well. However, while particular SCP-enabled storage functionality is described herein, one of skill in the art in possession of the present disclosure will appreciate how the SCP devices 406 described herein may allocate SCP hardware and/or perform other enhanced functionality for an LCS provided via allocation of its resource devices 404a-404c while remaining within the scope of the present disclosure as well.

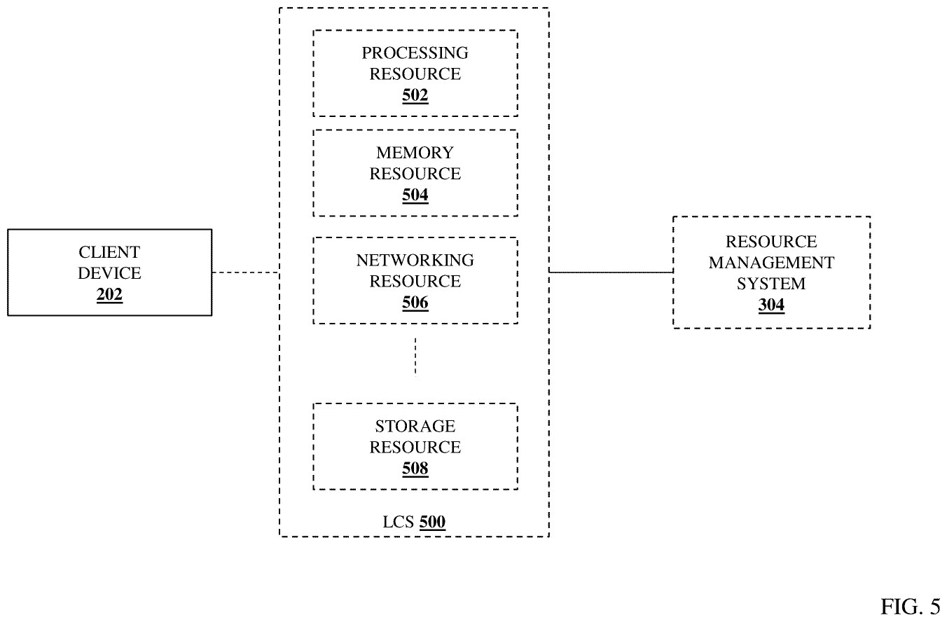

With reference to FIG. 5, an example of the provisioning of an LCS 500 to one of the client device(s) 202 is illustrated. For example, the LCS provisioning system 200 may allow a user of the client device 202 to express a “workload intent” that describes the general requirements of a workload that user would like to perform (e.g., “I need an LCS with 10 gigahertz (Ghz) of processing power and 8 gigabytes (GB) of memory capacity for an application requiring 20 terabytes (TB) of high-performance protected-object-storage for use with a hospital-compliant network”, or “I need an LCS for a machine-learning environment requiring Tensorflow processing with 3 TBs of Accelerator PMEM memory capacity”). As will be appreciated by one of skill in the art in possession of the present disclosure, the workload intent discussed above may be provided to one of the LCS provisioning subsystems 206a-206c, and may be satisfied using resource systems that are included within that LCS provisioning subsystem, or satisfied using resource systems that are included across the different LCS provisioning subsystems 206a-206c.

As such, the resource management system 304 in the LCS provisioning subsystem that received the workload intent may operate to compose the LCS 500 using resource devices 404a-404c in the resource systems 306a-306c/400 in that LCS provisioning subsystem, and/or resource devices 404a-404c in the resource systems 306a-306c/400 in any of the other LCS provisioning subsystems. FIG. 5 illustrates the LCS 500 including a processing resource 502 allocated from one or more processing systems provided by one or more of the resource devices 404a-404c in one or more of the resource systems 306a-306c/400 in one or more of the LCS provisioning subsystems 206a-206c, a memory resource 504 allocated from one or more memory systems provided by one or more of the resource devices 404a-404c in one or more of the resource systems 306a-306c/400 in one or more of the LCS provisioning subsystems 206a-206c, a networking resource 506 allocated from one or more networking devices provided by one or more of the resource devices 404a-404c in one or more of the resource systems 306a-306c/400 in one or more of the LCS provisioning subsystems 206a-206c, and/or a storage resource 508 allocated from one or more storage devices provided by one or more of the resource devices 404a-404c in one or more of the resource systems 306a-306c/400 in one or more of the LCS provisioning subsystems 206a-206c.

Furthermore, as will be appreciated by one of skill in the art in possession of the present disclosure, any of the processing resource 502, memory resource 504, networking resource 506, and the storage resource 508 may be provided from a portion of a processing system (e.g., a core in a processor, a time-slice of processing cycles of a processor, etc.), a portion of a memory system (e.g., a subset of memory capacity in a memory device), a portion of a storage device (e.g., a subset of storage capacity in a storage device), and/or a portion of a networking device (e.g., a portion of the bandwidth of a networking device). Further still, as discussed above, the SCP device(s) 406 in the resource systems 306a-306c/400 that allocate any of the resource devices 404a-404c that provide the processing resource 502, memory resource 504, networking resource 506, and the storage resource 508 in the LCS 500 may also allocate their SCP hardware and/or perform enhanced functionality (e.g., the enhanced storage functionality in the specific examples provided above) for any of those resources that may otherwise not be available in the processing system, memory system, storage device, or networking device allocated to provide those resources in the LCS 500.

With the LCS 500 composed using the processing resources 502, the memory resources 504, the networking resources 506, and the storage resources 508, the resource management system 304 may provide the client device 202 resource communication information such as, for example, Internet Protocol (IP) addresses of each of the systems/devices that provide the resources that make up the LCS 500, in order to allow the client device 202 to communicate with those systems/devices in order to utilize the resources that make up the LCS 500. As will be appreciated by one of skill in the art in possession of the present disclosure, the resource communication information may include any information that allows the client device 202 to present the LCS 500 to a user in a manner that makes the LCS 500 appear the same as an integrated physical system having the same resources as the LCS 500.

Thus, continuing with the specific example above in which the user provided the workload intent defining an LCS with a 10 Ghz of processing power and 8 GB of memory capacity for an application with 20 TB of high-performance protected object storage for use with a hospital-compliant network, the processing resources 502 in the LCS 500 may be configured to utilize 10 Ghz of processing power from processing systems provided by resource device(s) in the resource system(s), the memory resources 504 in the LCS 500 may be configured to utilize 8 GB of memory capacity from memory systems provided by resource device(s) in the resource system(s), the storage resources 508 in the LCS 500 may be configured to utilize 20 TB of storage capacity from high-performance protected-object-storage storage device(s) provided by resource device(s) in the resource system(s), and the networking resources 506 in the LCS 500 may be configured to utilize hospital-compliant networking device(s) provided by resource device(s) in the resource system(s).

Similarly, continuing with the specific example above in which the user provided the workload intent defining an LCS for a machine-learning environment for Tensorflow processing with 3 TBs of Accelerator PMEM memory capacity, the processing resources 502 in the LCS 500 may be configured to utilize TPU processing systems provided by resource device(s) in the resource system(s), and the memory resources 504 in the LCS 500 may be configured to utilize 3 TB of accelerator PMEM memory capacity from processing systems/memory systems provided by resource device(s) in the resource system(s), while any networking/storage functionality may be provided for the networking resources 506 and storage resources 508, if needed.

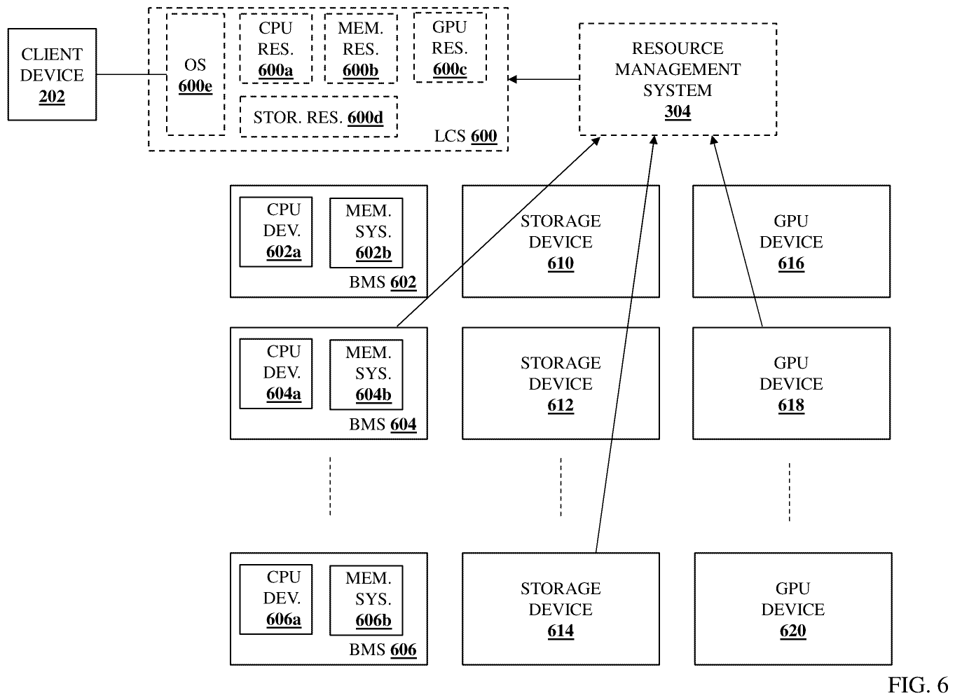

With reference to FIG. 6, another example of the provisioning of an LCS 600 to one of the client device(s) 202 is illustrated. As will be appreciated by one of skill in the art in possession of the present disclosure, many of the LCSs provided by the LCS provisioning system 200 will utilize a “compute” resource (e.g., provided by a processing resource such as an x86 processor, an AMD processor, an ARM processor, and/or other processing systems known in the art, along with a memory system that includes instructions that, when executed by the processing system, cause the processing system to perform any of a variety of compute operations known in the art), and in many situations those compute resources may be allocated from a Bare Metal Server (BMS) and presented to a client device 202 user along with storage resources, networking resources, other processing resources (e.g., GPU resources), and/or any other resources that would be apparent to one of skill in the art in possession of the present disclosure.

As such, in the illustrated embodiment, the resource systems 306a-306c available to the resource management system 304 include a Bare Metal Server (BMS) 602 having a Central Processing Unit (CPU) device 602a and a memory system 602b, a BMS 604 having a CPU device 604a and a memory system 604b, and up to a BMS 606 having a CPU device 606a and a memory system 606b. Furthermore, one or more of the resource systems 306a-306c includes resource devices 404a-404c provided by a storage device 610, a storage device 612, and up to a storage device 614. Further still, one or more of the resource systems 306a-306c includes resource devices 404a-404c provided by a Graphics Processing Unit (GPU) device 616, a GPU device 618, and up to a GPU device 620.

FIG. 6 illustrates how the resource management system 304 may compose the LCS 600 using the BMS 604 to provide the LCS 600 with CPU resources 600a that utilize the CPU device 604a in the BMS 604, and memory resources 600b that utilize the memory system 604b in the BMS 604. Furthermore, the resource management system 304 may compose the LCS 600 using the storage device 614 to provide the LCS 600 with storage resources 600d, and using the GPU device 318 to provide the LCS 600 with GPU resources 600c. As illustrated in the specific example in FIG. 6, the CPU device 604a and the memory system 604b in the BMS 604 may be configured to provide an operating system 600e that is presented to the client device 202 as being provided by the CPU resources 600a and the memory resources 600b in the LCS 600, with operating system 600e utilizing the GPU device 618 to provide the GPU resources 600c in the LCS 600, and utilizing the storage device 614 to provide the storage resources 600d in the LCS 600. The user of the client device 202 may then provide any application(s) on the operating system 600e provided by the CPU resources 600a/CPU device 604a and the memory resources 600b/memory system 604b in the LCS 600/BMS 604, with the application(s) operating using the CPU resources 600a/CPU device 604a, the memory resources 600b/memory system 604b, the GPU resources 600c/GPU device 618, and the storage resources 600d/storage device 614.

Furthermore, as discussed above, the SCP device(s) 406 in the resource systems 306a-306c/400 that allocates any of the CPU device 604a and memory system 604b in the BMS 604 that provide the CPU resource 600a and memory resource 600b, the GPU device 618 that provides the GPU resource 600c, and the storage device 614 that provides storage resource 600d, may also allocate SCP hardware and/or perform enhanced functionality (e.g., the enhanced storage functionality in the specific examples provided above) for any of those resources that may otherwise not be available in the CPU device 604a, memory system 604b, storage device 614, or GPU device 618 allocated to provide those resources in the LCS 500.

However, while simplified examples are described above, one of skill in the art in possession of the present disclosure will appreciate how multiple devices/systems (e.g., multiple CPUs, memory systems, storage devices, and/or GPU devices) may be utilized to provide an LCS. Furthermore, any of the resources utilized to provide an LCS (e.g., the CPU resources, memory resources, storage resources, and/or GPU resources discussed above) need not be restricted to the same device/system, and instead may be provided by different devices/systems over time (e.g., the GPU resources 600c may be provided by the GPU device 618 during a first time period, by the GPU device 616 during a second time period, and so on) while remaining within the scope of the present disclosure as well. Further still, while the discussions above imply the allocation of physical hardware to provide LCSs, one of skill in the art in possession of the present disclosure will recognize that the LCSs described herein may be composed similarly as discussed herein from virtual resources. For example, the resource management system 304 may be configured to allocate a portion of a logical volume provided in a Redundant Array of Independent Disk (RAID) system to an LCS, allocate a portion/time-slice of GPU processing performed by a GPU device to an LCS, and/or perform any other virtual resource allocation that would be apparent to one of skill in the art in possession of the present disclosure in order to compose an LCS.

Similarly as discussed above, with the LCS 600 composed using the CPU resources 600a, the memory resources 600b, the GPU resources 600c, and the storage resources 600d, the resource management system 304 may provide the client device 202 resource communication information such as, for example, Internet Protocol (IP) addresses of each of the systems/devices that provide the resources that make up the LCS 600, in order to allow the client device 202 to communicate with those systems/devices in order to utilize the resources that make up the LCS 600. As will be appreciated by one of skill in the art in possession of the present disclosure, the resource communication information allows the client device 202 to present the LCS 600 to a user in a manner that makes the LCS 600 appear the same as an integrated physical system having the same resources as the LCS 600.

As will be appreciated by one of skill in the art in possession of the present disclosure, the LCS provisioning system 200 discussed above solves issues present in conventional Information Technology (IT) infrastructure systems that utilize “purpose-built” devices (server devices, storage devices, etc.) in the performance of workloads and that often result in resources in those devices being underutilized. This is accomplished, at least in part, by having the resource management system(s) 304 “build” LCSs that satisfy the needs of workloads when they are deployed. As such, a user of a workload need simply define the needs of that workload via a “manifest” expressing the workload intent of the workload, and resource management system 304 may then compose an LCS by allocating resources that define that LCS and that satisfy the requirements expressed in its workload intent, and present that LCS to the user such that the user interacts with those resources in same manner as they would physical system at their location having those same resources.

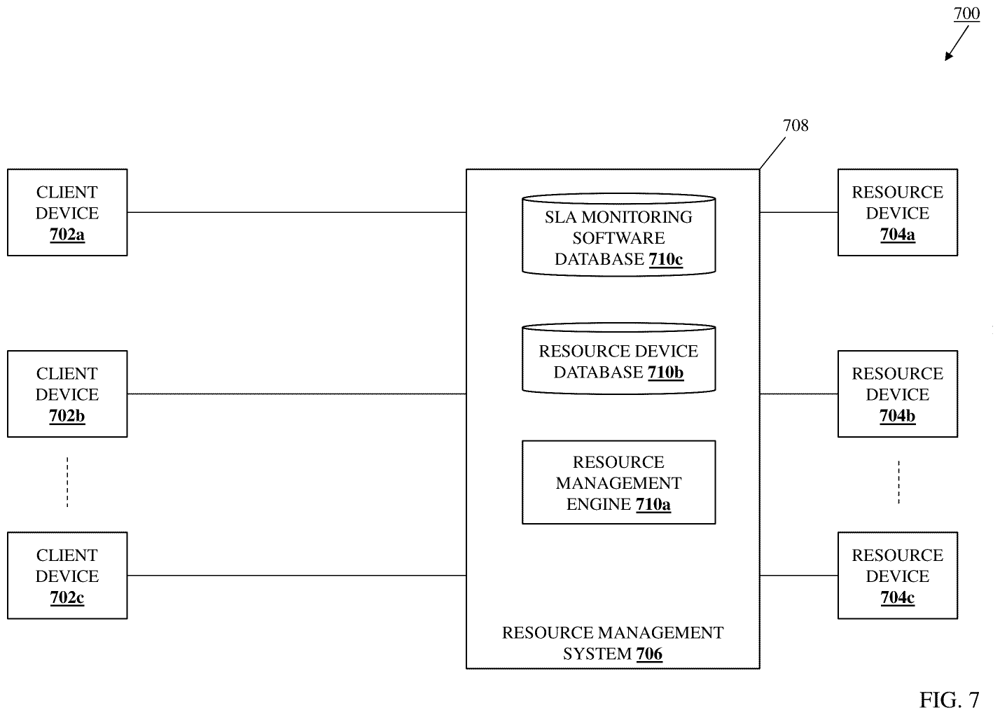

Referring now to FIG. 7, an embodiment of a workload SLA satisfaction system 700 is illustrated that may be provided using the LCS provisioning system 200 described above with reference to FIG. 2, the LCS provisioning subsystem described above with reference to FIG. 3, and the resource system 400 described above with reference to FIG. 4, and may operate similarly as described with reference to FIGS. 5 and 6. In the illustrated embodiment, the workload SLA satisfaction system 700 includes a plurality of client devices 702a, 702b, and up to 702c that may be provided by any of the client device(s) 202 of FIG. 2. Furthermore, the workload SLA satisfaction system 700 also includes a plurality of resource devices 704a, 704b, and up to 704c that may be provided by any of the resource devices 404a-404c of FIG. 4; the CPU device/memory system combinations 602a/602b, 604a/604b, and 606a/606b in the BMSs 602, 604, and 606, respectively, of FIG. 6; the storage devices 610, 612, and 614 of FIG. 6; the GPU devices 616, 618, and 620 of FIG. 6; and/or any other resource devices described above. Finally, in the illustrated embodiment, the workload SLA satisfaction system 700 includes a resource management system 706 that is coupled to the client devices 702a-702c and the resource devices 704a-704c, and that may be provided by the resource management system 304 of FIGS. 3, 5, and 6.

In the illustrated embodiment, the resource management system 706 includes a chassis 708 that houses and/or otherwise supports the components of the resource management system 706, only some of which are illustrated and described below. For example, the chassis 708 may house and/or support a resource management processing system (not illustrated, but which may be similar to the processor 102 discussed above with reference to FIG. 1) and a resource management memory system (not illustrated, but which may be similar to the memory 114 discussed above with reference to FIG. 1) that is coupled to the resource management processing system and that includes instructions that, when executed by the resource management processing system, cause the resource processing system to provide a resource management engine 710a that is configured to perform the functionality of the resource management engines, resource management subsystems, and/or resource management systems discussed below.

The chassis 302 may also house a resource management storage system (not illustrated, but which may be similar to the storage 108 discussed above with reference to FIG. 1) that is coupled to the resource management engine 710 (e.g., via a coupling between the resource management storage system and the resource management processing system) and that includes a resource device database 710b that is configured to store information identifying the resource devices 704a-704c coupled to the resource management system 706 as well as any of other resource device information utilized by the resource management engine 710a as discussed below, and an SLA monitoring software database 710c that is configured to store SLA monitoring software as well as any of other SLA monitoring information utilized by the resource management engine 710a as discussed below. However, while a specific resource management system 706 has been illustrated and described, one of skill in the art in possession of the present disclosure will recognize that resource management systems (or other devices operating according to the teachings of the present disclosure in a manner similar to that described below for the resource management system 706) may include a variety of components and/or component configurations for providing conventional resource management functionality, as well as the workload SLA satisfaction functionality discussed below, while remaining within the scope of the present disclosure as well.

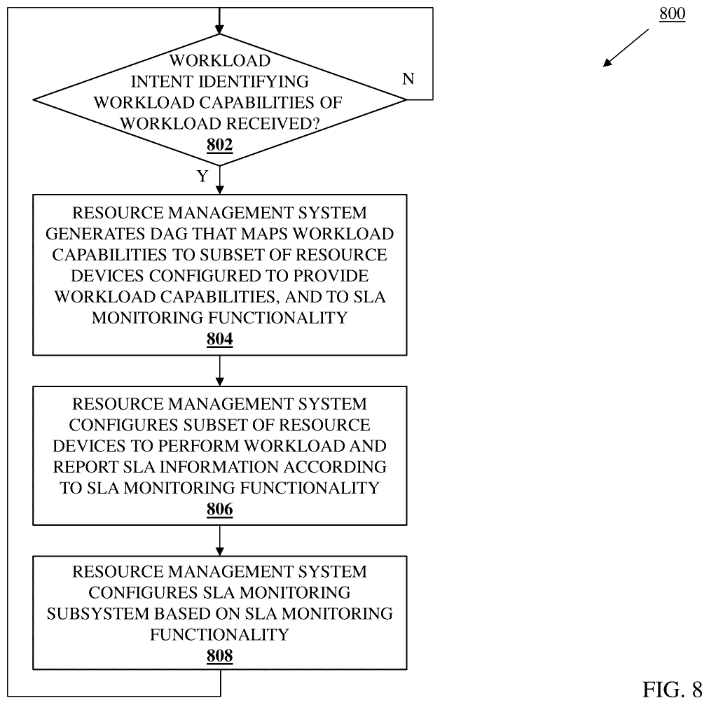

Referring now to FIG. 8, an embodiment of a method 800 for satisfying an SLA for a workload is illustrated. As discussed below, the systems and methods of the present disclosure provide for the satisfaction of SLAs for workloads performed using distributed, shared, and dynamically-allocated resource devices in multiple resource systems. For example, the workload Service Level Agreement (SLA) satisfaction system of the present disclosure may include a resource management system that is coupled to a client device and each of a plurality of resource devices. The resource management system receives a workload intent that identifies workload capabilities of a first workload, generates a Directed Acyclic Graph (DAG) that maps the workload capabilities to a first subset of the plurality of resource devices that are configured to provide the workload capabilities and to Service Level Agreement (SLA) monitoring functionality, configures the first subset of the plurality of resource devices to perform the first workload and report SLA information according to the SLA monitoring functionality, and configures an SLA monitoring subsystem based on the SLA monitoring functionality to receive the SLA information during performance of the first workload by the first subset of the plurality of resource devices, and perform a management operation based on the SLA information. As such, distributed resource devices may be dynamically utilized to perform multiple workloads in a manner that satisfies the SLAs for those workloads.

The method 800 begins at decision block 802 where the method 800 proceeds depending on whether a workload intent identifying workload capabilities of a workload is received. Similarly as discussed above with reference to FIG. 5, any user or administrator may use any of the client devices 702a-702c to express a workload intent that describes the general requirements of a workload that user would like to be performed. In a specific example, the client devices 702a-702c may be configured to allow such users to generate the workload intents of the present disclosure via a Topology and Orchestration Specification for Cloud Applications (TOSCA) subsystem that utilizes a TOSCA modeling language, and that in some cases includes a TOSCA template that enables the structured input of the workload capabilities desired for a workload, with those workload capabilities expressed using the TOSCA modeling language to define “hardware” workload capabilities and corresponding SLAs desired for the workload (e.g., a particular networking interface with a “highly-available” SLA in the specific examples provided below), functionality dependencies and corresponding SLAs for the workload capabilities desired for the workload (e.g., different networking connections that use the highly-available networking interface and that each require a particular networking bandwidth in the specific examples provided below), and/or other workload intent information that would be apparent to one of skill in the art in possession of the present disclosure.

Continuing with the specific example introduced above, the workload SLA satisfaction system of the present disclosure may utilize a TOSCA-compliant workload capabilities dictionary, workload capabilities lookup table, and/or other workload capabilities TOSCA information that may be generated by the workload SLA satisfaction system provider, and that provides a workload capabilities “menu” that allows a user to select workload capabilities for a workload they would like performed. As such, some users may utilize that workload capabilities TOSCA information (e.g., the TOSCA-compliant workload capabilities dictionary discussed above) to generate the workload intent including the workload capabilities for the desired workload (e.g., write code that identifies those workload capabilities using the TOSCA-compliant workload capabilities dictionary) at decision block 802. However, in other examples, a workload capabilities User Interface (UI) may be presented to a user that includes the workload capabilities TOSCA information in a plurality of “drop-down” fields, enabling the user to select the workload capabilities from the “drop-down” fields in that workload capabilities UI to identify the workload capabilities desired for their workload, with the workload capabilities UI then automatically generating the workload intent that includes those workload capabilities (e.g., automatically generating code that identifies those workload capabilities using the workload capabilities TOSCA information).

However, while some specific examples of the generation of a workload intent have been described, one of skill in the art in possession of the present disclosure will appreciate how the workload intents of the present disclosure may be generated in a variety of manners to request workloads via a workload intent that is annotated with each of the workload capabilities that are desired for that workload. As such, at decision block 802, the resource management engine 710a in the resource management system 706 may monitor for workload intents provided by the client devices 702a-702c. If, at decision block 802, no workload intent is received, the method 800 returns to decision block 802. As such, the method 800 may loop such that the resource management engine 710a continues to monitor for a workload intent provided by the client devices 702a-702c until a workload intent is received.

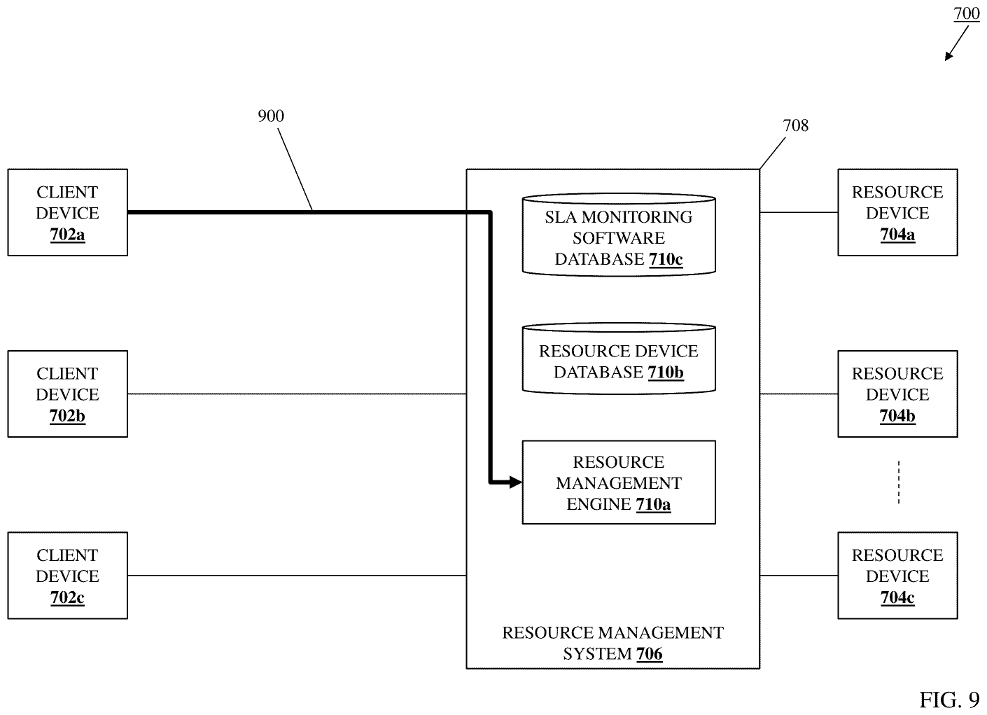

If, at decision block 802, the workload intent is received, the method 800 proceeds to block 804 where a resource management system generates a DAG that maps the workload capabilities to a subset of resource devices that are configured to provide the workload capabilities, and to SLA monitoring functionality. With reference to FIG. 9, in an embodiment of decision block 802, the client device 702a may perform workload intent provisioning operations 900 that include generating and transmitting a workload intent similarly as described above, with that workload intent received by the resource management engine 710a in the resource management system 706. Furthermore, while the client device 702a is illustrated and described herein as providing the workload intent during the method 800, as described below, any of the other client devices 702b-702c may provide workload intents in a similar manner while remaining within the scope of the present disclosure as well.

As will be appreciated by one of skill in the art in possession of the present disclosure, DAGs may be utilized to represent dependencies and the relationships between entities, and in the context of the present disclosure are used to specify the capabilities of any number of “inventory objects” or “assets” (e.g., resource devices that may include hardware, software, etc.) as it relates to a larger system (e.g., the LCS provisioning systems discussed above). As described herein, capabilities of resource devices and/or subsystems may be discovered and identified through monitoring, analysis, automated processes, and/or using other techniques that would be apparent to one of skill in the art in possession of the present disclosure, and the storage of those capabilities in association with the resource devices and/or subsystems that possess them operates to map capabilities of inventoried physical and logical assets (e.g., tasks, services, and applications) in the LCS provisioning system. As such, the acyclic DAGs described herein provide scaling of available resource devices and other assets without conventional table/index dependencies, as they allow for the addition of elements over time without the need to update the entire structure, may be used to support parallel processing and allow more than one inventory/capability action to be performed asynchronously, and/or provide other benefits that would be apparent to one of skill in the art in possession of the present disclosure.

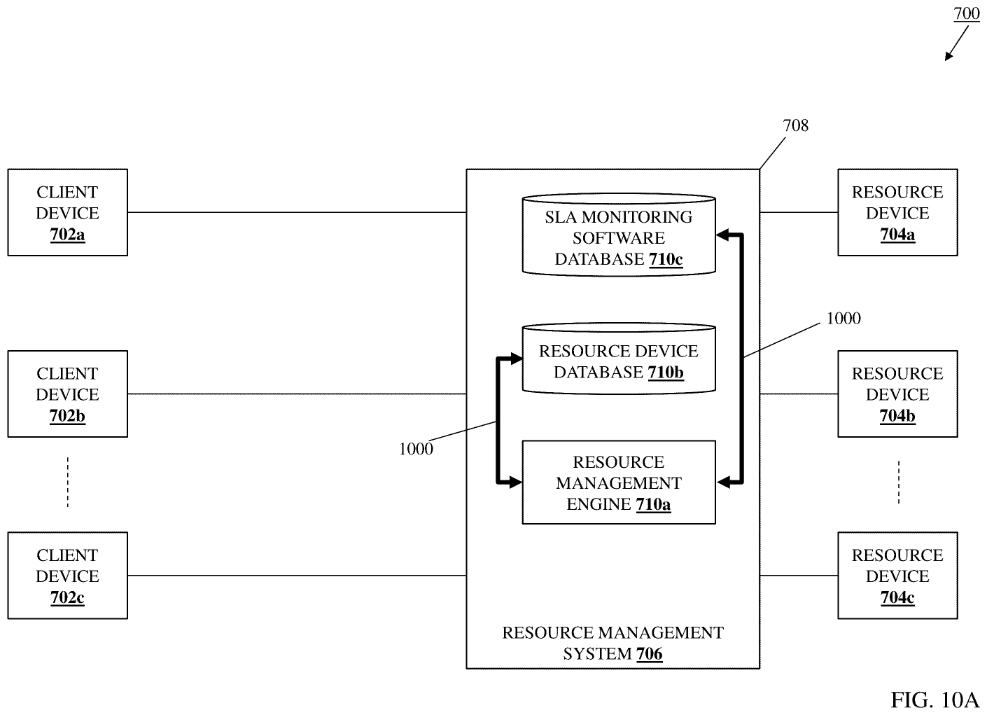

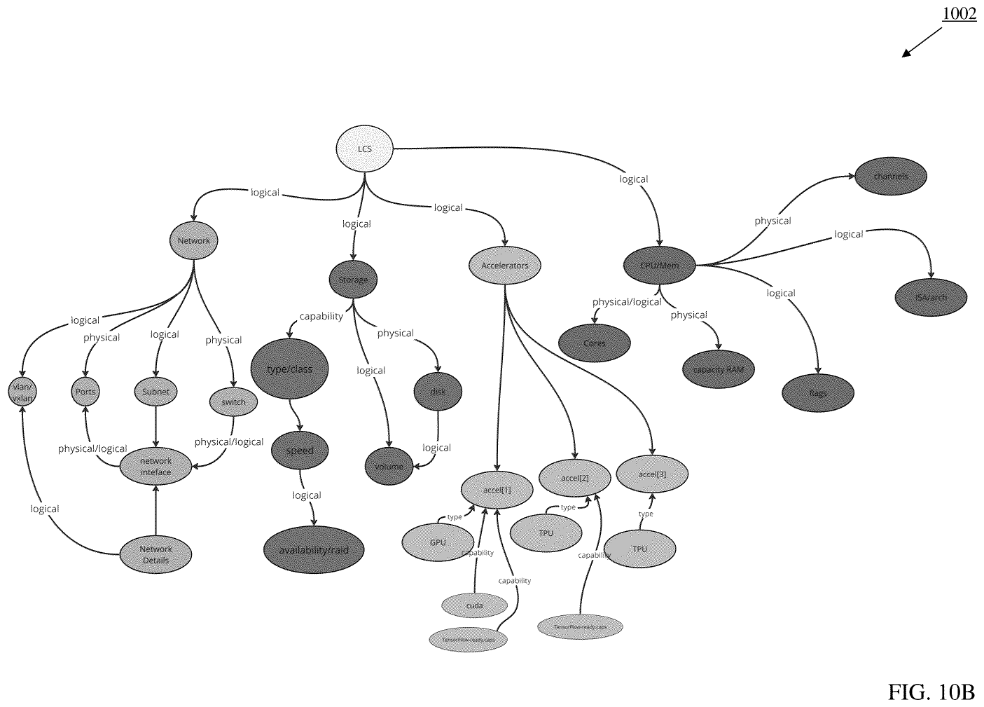

With reference to FIG. 10A, in an embodiment of block 804 and in response to receiving the workload intent, the resource management engine 710a in the resource management system 706 may perform DAG generation operations 1000 that may include accessing the resource device database 710b to identify a subset of the resource devices 704a-704c that are configured to provide the workload capabilities that are included in the workload intent, map that subset of the resource devices 704a-704c to a DAG, access the SLA monitoring software database 710c to identify SLA monitoring software that provides SLA monitoring functionality that is configured to monitor for the satisfaction of SLAs included in the workload capabilities provided in the workload intent, and map that SLA monitoring functionality to the DAG. FIG. 10B provides an example of a DAG 1002 that maps “Network”, “Storage”, “Accelerators”, and “CPU/Mem” resource devices and capabilities for an “LCS”, but one of skill in the art in possession of the present disclosure will appreciate how a DAG may map any of a variety of resource devices and capabilities while remaining within the scope of the present disclosure. While not included in the DAG 1002, one of skill in the art in possession of the present disclosure will appreciate how SLA monitoring functionality may be represented by “edges” and “vertices” in the DAG 1002 (e.g., SLA monitoring functionality may be represented in the DAG 1002 by an SLA monitoring “edge” that is connected to the “availability/RAID” vertex in the “Storage” portion of the DAG 1002, as well as to a “desired uptime” vertex that specifies a desired uptime for the RAID).

To provide a specific example, the workload intent received at decision block 804 may identify a particular networking interface with a “highly-available” SLA as a “hardware” workload capability and corresponding SLA desired for its workload, and may identify different networking connections that use the highly-available networking interface and that each require a particular networking bandwidth as functionality dependencies and corresponding SLAs for the workload capabilities desired for the workload (e.g., an LCS including an I/O network connection to a web server for customer data traffic, and a storage network connection to a storage system that provides a data store for the web server in the specific example provided below). As will be appreciated by one of skill in the art in possession of the present disclosure, the SLA monitoring software that provides the SLA monitoring functionality to monitor and enforce SLAs for the highly available networking interface and the networking connection bandwidths described above (e.g., software drivers, telemetry data retrieval, scheduling operations, drift detection, etc.) presents a multi-dimensional problem that requires multiple software services and data inputs/outputs to solve. For example, any I/O request received via the I/O network connection described above may result in a read/write operation via the storage network connection, and the sharing of the highly-available networking interface discussed above (e.g., which may be provided by a single physical interface) by the I/O network connection and the storage network connection require monitoring and enforcement of the SLAs discussed above via SLA monitoring software that operates on networking hardware used to provide the LCS, and that accesses data traffic transmitted by that LCS.

As such, the generation of the DAG and its mapping to the subset of resource devices 704a-704c and to the SLA monitoring functionality may be configured to both identify the subset of resource devices 704a-704c that are configured to provide the workload capabilities desired for any particular workload, as well as configure those resource devices to provide those workload capabilities according their corresponding SLAs, and provide the SLA monitoring functionality to monitor and enforce those SLAs, with that SLA monitoring functionality also configured to rectify situations in which any of those SLAs are not being satisfied. Furthermore, one of skill in the art in possession of the present disclosure will appreciate how the mapping of the DAG to workload capabilities provided via the workload capabilities TOSCA information described above provides dynamic resource device/SLA monitoring functionality mappings that allow the resource devices and/or SLA monitoring functionality to be modified during the performance of the workload.

As will be appreciated by one of skill in the art in possession of the present disclosure, TOSCA is a standard primer for describing computational topologies, and allows relationships between different component types to be specified (e.g., similarly to the use of the DAGs described above in modeling inventory and capabilities as dependent relational). As such, the TOSCA information described herein may be used to request capabilities of a scheduler in the resource management system, which may cause that scheduler to parse the TOSCA information and determine the needed inventory (as annotated in the DAG that directly or indirectly requests those capabilities). Furthermore, any capability that is requested and that is not directly available (i.e. via a physical resource) may still be assembled from virtual resources using available physical resources. In the event of a failure (i.e., where an SLA needs to be still satisfied but existing resources no longer meet its criteria), the DAG may include a list of capabilities that can be used to address that failure, and that list may be used to schedule the resource devices needed to do so. The scheduler need not know if the capability can be satisfied alone, rather, the scheduler will operate to satisfy the SLA(s) of the system, and from there the processing of the directives of the scheduler will ultimately yield new, “fine grain” TOSCA information that represents an actual composition intent (and not necessarily a more general, courser request).

As will be appreciated by one of skill in the art in possession of the present disclosure, the initial mapping of the DAG and the resource devices/SLA monitoring functionality for a workload (i.e., as opposed to any subsequent modification of that mapping, discussed in further detail below) may provide an initial “best fit” of resource devices and SLA monitoring functionality that minimizes the resource devices 704a-704c that are used to perform the corresponding workload. As will be appreciated by one of skill in the art in possession of the present disclosure, such a “best fit” of resource devices and SLA monitoring functionality used to perform any particular workload may be constrained by the performance of other workloads, and may require a sub-optimal solution that may, for example, satisfy SLAs for the workload while performing that workload using a sub-optimal subset of the resource devices 704a-704c.

In some examples, the minimization of the resource devices 704a-704c used to perform any workload may be enabled via the identification of the workload capabilities in the workload capabilities TOSCA information discussed above, with any increases in workload capability granularity provided via those identifications enabling further minimization of the resource devices 704a-704c used to perform any workload. As will be appreciated by one of skill in the art in possession of the present disclosure, the minimization of the resource devices 704a-704c used to perform any workload will prevent the inefficient use of the resource devices 704a-704c and will operate to extract the most value out of the resource systems and their resource devices. Furthermore, one of skill in the art in possession of the present disclosure will appreciate how the minimization of the resource devices 704a-704c used to perform any workload will benefit users that pay for a set allocation of the resource devices by, for example, not using more of that set allocation than is necessary to perform any particular workload.

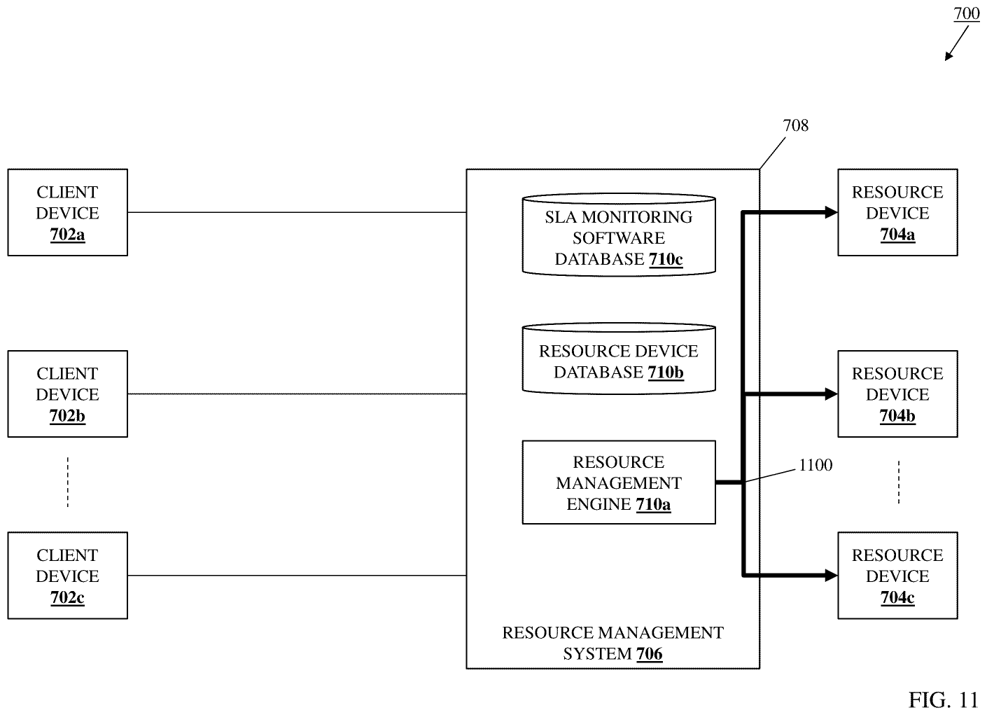

The method 800 then proceeds to block 806 where the resource management system configures the subset of the resource devices to perform the workload and report SLA information according to the SLA monitoring functionality. With reference to FIG. 11, in an embodiment of block 806, the resource management engine 710a in the resource management system 706 may perform resource device configuration operations 1100 that may include configuring the subset of the resource devices 704a-704c that were mapped to the DAG at block 804 to perform the workload according to the workload intent received from the client device 702a at decision block 802, as well as report SLA information according to the SLA monitoring functionality that was mapped to the DAG at block 804. Furthermore, while the resource management engine 710a is illustrated and described as performing the resource device configuration operations 1100 on all of the resource devices 704a-704c for the workload requested by the client device 702a, one of skill in the art in possession of the present disclosure will appreciate how the resource management engine 710a may perform the resource device configuration operations 1100 on any combination of the resource devices 704a-704c for workloads requested by any of the client devices 702b-702c while remaining within the scope of the present disclosure as well.

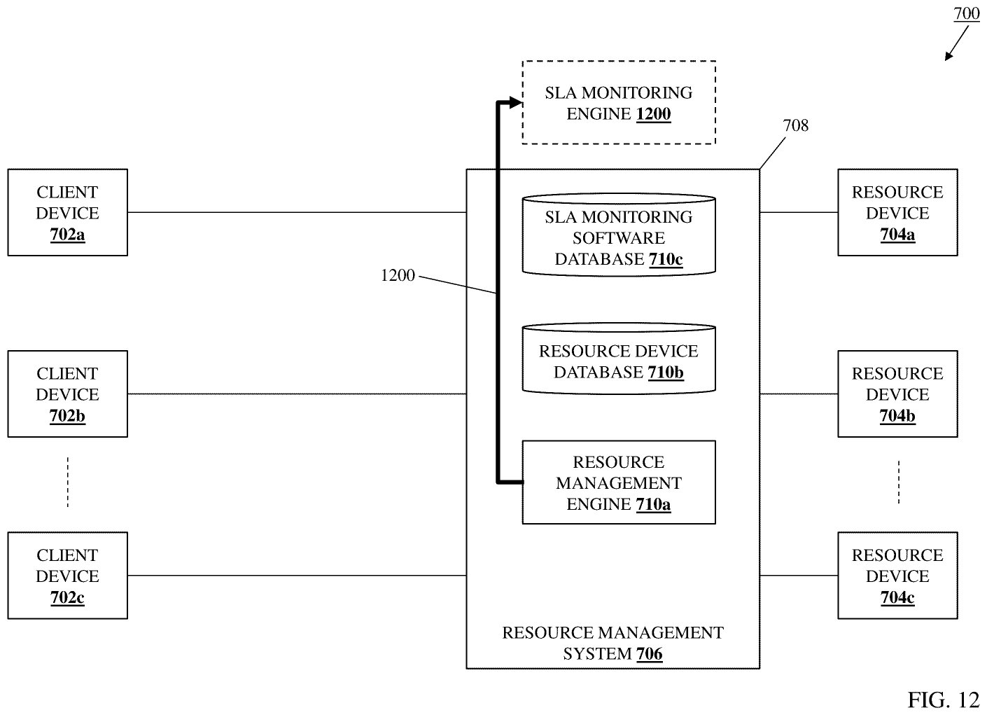

The method 800 then proceeds to block 808 where the resource management system configures an SLA monitoring subsystem based on the SLA monitoring functionality. With reference to FIG. 12, in an embodiment of block 808, the resource management engine 710a in the resource management system 706 may perform SLA monitoring subsystem configuration operations 1200 that may include configuring an SLA monitoring engine 1200 based on the SLA monitoring functionality that was mapped to the DAG at block 804. For example, at block 808, the resource management engine 710a may identify a processing system and memory system (e.g., included in the resource management system 706, included in a resource system or the resource devices described above, and/or provided in any other manner that would be apparent to one of skill in the art in possession of the present disclosure), and may provide instructions on that memory system that, when executed by that processing system, cause that processing system to provide the SLA monitoring engine 1200 that is configured to perform the functionality of the SLA monitoring engines and/or SLA monitoring subsystems described below. As such, while not explicitly illustrated in FIG. 12, one of skill in the art in possession of the present disclosure will appreciate how the SLA monitoring engine 1200 may be communicatively coupled to any or all of the subset of resource devices 704a-704c that were configured to perform a workload.

The method 800 then returns to decision block 804. As such, the method 800 may loop such that the resource management engine 710a in the resource management system 706 receives respective workload intents from the client devices 702a-702c and, for each of those workload intents, generates a DAG that maps workload capabilities in that workload intent to a respective subset of the resource devices 704a-704b and to SLA monitoring functionality as described above, configures that respective subset of resource devices to perform the workload and report SLA information as described above, and configures the SLA monitoring subsystem 1200 to perform SLA monitoring as described above. Thus, following multiple loops of the method 800, different subsets of the resource devices 704a-704c may operate to perform respective workloads and report corresponding SLA information associated with the performance of those respective workloads, with the SLA monitoring subsystem 1200 configured to monitor each of those subsets of resource devices and their corresponding workloads for SLA satisfaction.

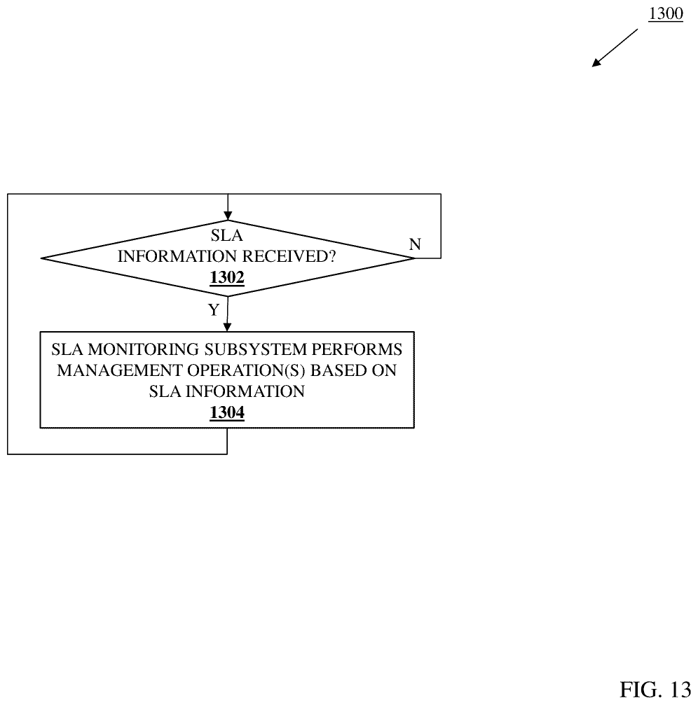

Referring now to FIG. 13, an embodiment of a method 1300 for SLA monitoring is illustrated that may be performed by the SLA monitoring subsystem 1200 following at least one iteration of the method 800. The method 1300 begins at decision block 1302 where the method 1300 proceeds depending on whether SLA information is received. In an embodiment, at decision block 1302, the SLA monitoring engine 1200 may perform SLA monitoring operations that include monitoring for SLA information that may be reported by one or more of the resource devices 704a-704b and/or the LCSs provided by one or more of the resource devices 704a-704b as per their configuration at block 806 as described above. If, at decision block 1302, no SLA information is received, the method 1300 returns to decision block 1302. As such, the method 1300 may loop such that the SLA monitoring engine 1200 continues to monitor for SLA information until SLA information is received from one or more of the resource devices 704a-704b and/or the LCSs provided by one or more of the resource devices 704a-704b.

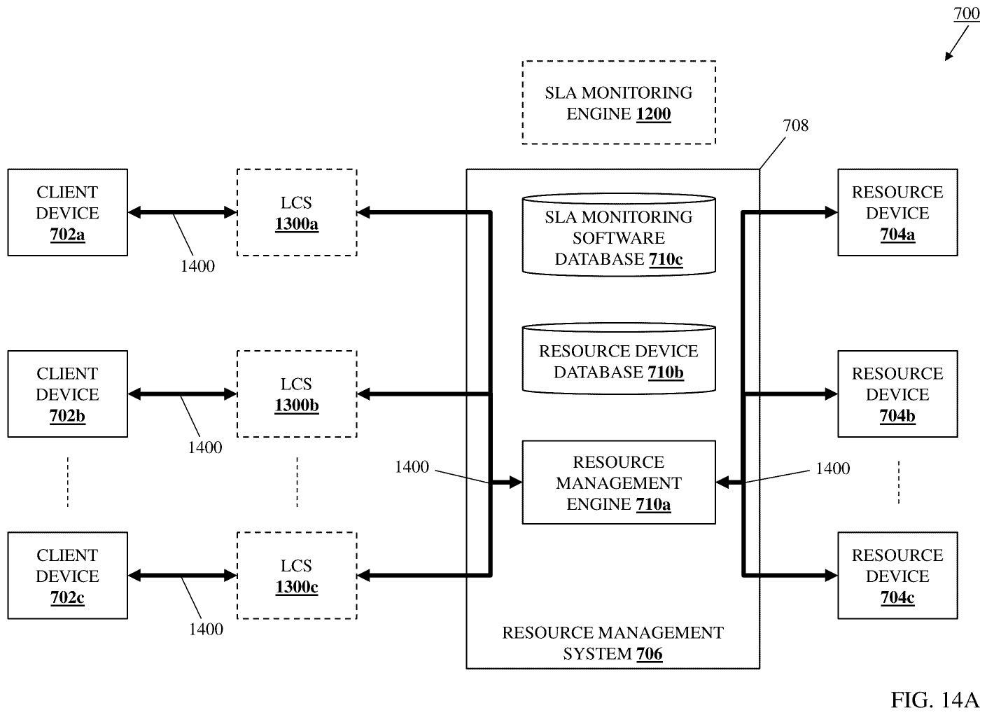

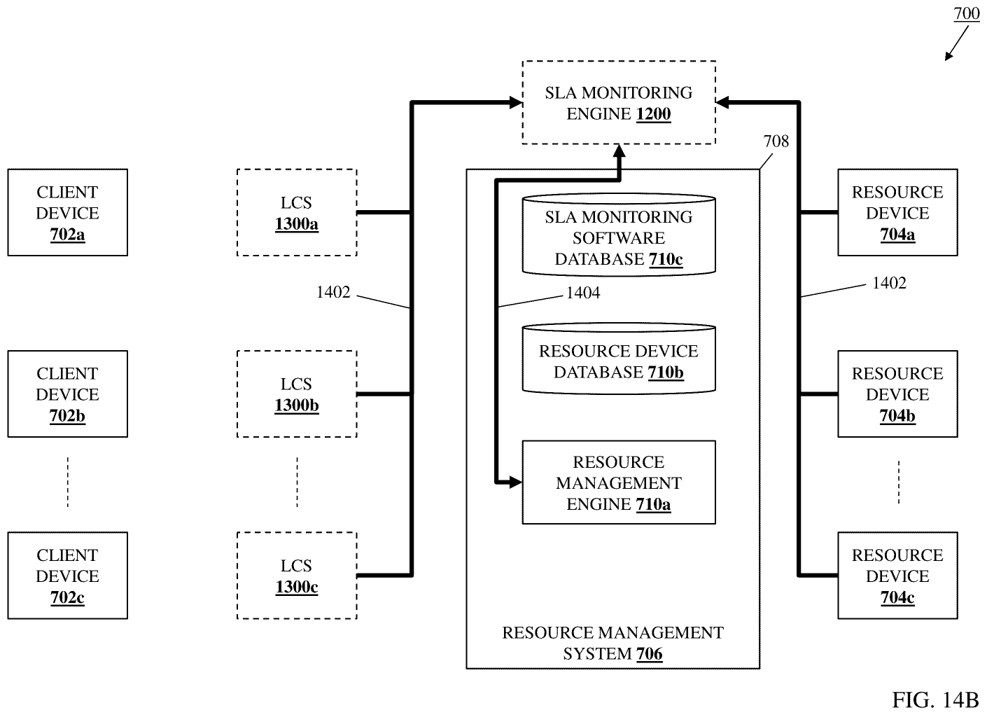

If, at decision block 1302, the SLA information is received, the method 1300 proceeds to block 1304 where the SLA monitoring subsystem performs at least one management operation based on the SLA information. With reference to FIG. 14A, in an embodiment of decision block 1302, the resource management engine 710a in the resource management system 706 may perform LCS provisioning operations 1400 that include utilizing subsets of the resource devices 704a-704c to provide LCSs that perform workloads requested by the client devices 702a-702c, with the illustrated example including the resource management engine 710a utilizing a first subset of the resource devices 704a-704c to provide an LCS 1300a that performs a workload requested by the client device 702a, utilizing a second subset of the resource devices 704a-704c that is different than the first subset of the resource devices 704a-704c to provide an LCS 1300b that performs a workload requested by the client device 702b, and utilizing a third subset of the resource devices 704a-704c that is different than the first subset and the second subset of the resource devices 704a-704c to provide an LCS 1300c that performs a workload requested by the client device 702c. Similarly as described above, while each of the resource devices 704a-704c is illustrated as being utilized to provide the LCSs 1300a-1300c that perform respective workloads, any combination of the resource devices 704a-704c may be utilized to provide any of the LCSs 1300a-1300c while remaining within the scope of the present disclosure as well.

With reference to FIG. 14B and in an embodiment of decision block 1302, the resource devices 704a-704c and/or the LCSs 1300a-1300c provided by the different subsets of those resource devices 704a-704c described above may perform SLA information reporting operations 1402 that include transmitting SLA information generated during the performance of the workloads by the LCSs 1300a-1300c to the SLA monitoring engine 1200. At block 1304 and in response to receiving the SLA information, the SLA monitoring engine 1200 may perform at least one management operation, and as illustrated in FIG. 14B, in some embodiments those management operation(s) may include resource management engine communication operations 1404 that include communicating with the resource management engine 710a in the resource management system 706 to perform the management operation(s).

As will be appreciated by one of skill in the art in possession of the present disclosure, the SLA information received by any resource device and/or the LCS it provides may include telemetry data generated by the resource device during its provisioning of the LCS and the performance of those workload by that LCS, LCS state information identifying a state of that LCS, and/or any other SLA information that one of skill in the art in possession of the present disclosure will recognize may be used in a feedback loop that is then used to perform the management operations at block 1304. For example, such management operations may include ensuring the minimization of the plurality of the resource devices 704a-704c that are being used to provide an LCS that performs a workload as described above, which one of skill in the art in possession of the present disclosure will recognize may include modifying the provisioning of that LCS by one of more of the resource devices 704a-704c such that a different subset of the resource devices 704a-704c are used to provide that LCS (e.g., as compared to an initial subset of resource devices used to provide that LCS) that is more efficient than the initial subset of resource devices used to provide that LCS. In such situations, the LCS provisioning modification may include modifying the DAG for the workload discussed above to map the workload capabilities to the different subset of the plurality of resource devices, and configuring the different subset of the plurality of resource devices to perform that workload, as well as any of the other configuration operations described above.

In a specific example of such functionality, relationships between resource device telemetry data, a current LCS state, a desired LCS state, and a registry of the workload capabilities of the workload being performed by the LCS may be serialized into a “single state” model that may be provided in “drift solver” provided by the SLA monitoring engine 1200, with the results of that drift solver being used to adjust the resource devices and/or other hardware being used to provide the LCS that performs the workload such that the plurality of resource devices 704a-704c being used to provide that LCS/perform that workload is minimized.

As will be appreciated by one of skill in the art in possession of the present disclosure, such dynamic operations may provide for improved responsiveness (e.g., dynamic resource provisioning against capabilities to allow the system to respond quickly to changes in demand, particularly during peak loads), and when coupled with existing techniques for “on-the-fly” workload migration will also provide better resource utilization (e.g., via the continuous balance of resource allocation based on telemetry to ensure that resources are not wasted and are available for other competing SLAs). These benefits will further lead to the prevention of service degradation as dynamic resource management can mitigate the risk of SLA management during peak loads (where tight SLA adherence increases) by redistributing workloads and resources to maintain performance levels (which may come at the expenses of SLAs being close to their limits as part of load balancing operations), as well as problem resolution (e.g., resolving problems resulting from failure to satisfy SLAs).

The dynamic operations described above also supports increased scalability, allowing the system to handle increased loads without compromising overall reliability, while scaling up resources during peak times and scaling down resources when demand decreases (e.g., turning on and off physical resources and removing logical resources when they're unneeded). The dynamic operations discussed above also provide resilience to fluctuations, allowing the system to be more resilient by preparing key secondary spare resources during peak periods, thus allowing dynamic adaptability to fluctuations in demand during peak periods and higher overall availability.

Furthermore, such management operations may account for different workloads and their respective SLAs, as well as the respective LCS states of the LCSs that provide those different workloads, by adjusting the subsets of resource devices being used to provide the LCSs that perform those workloads while ensuring that the SLAs included in their workload capabilities are satisfied as part of the minimization of the use of the plurality of the resource devices 704a-704c for providing any particular LCS that performs any particular workload. In some embodiments, the management operations performed by the SLA monitoring engine 1200 may include modifying the performance of a “second” workload by at least some of the resource devices 704a-704c in order to allow the performance of a “first” workload by a subset of the resource devices 704a-704c to satisfy SLA(s) included in the workload capabilities for that “first” workload.

As such, LCS state and resource device telemetry data may be utilized with any of a variety of drift policies to identify when SLAs for a workload or workload capability are not being satisfied and, in response, select a control loop to rectify such SLA drift by, for example, rescheduling the use of subsets of the resource devices 704a-704c to utilize those resource devices more efficiently, to reconfigure a resource device (e.g., move data from a storage device that is failed or operating slowly) that is providing an LCS, and/or perform other SLA rectification operations that would be apparent to one of skill in the art in possession of the present disclosure. In such situations, the management operations perform by the SLA monitoring engine 1200 may include reporting (e.g., via the resource management engine 710a) a violation of any SLA that is included in a workload capability of a workload. In such situations, the violation of an SLA by the performance of a workload by an LCS may be followed by a determination of a different subset of the resource devices 704a-704c that are capable of satisfying that SLA, modifying the DAG for the workload discussed above to map the workload capabilities to the different subset of the plurality of resource devices, and configuring the different subset of the plurality of resource devices to perform that workload, as well as any of the other configuration operations described above.

The method 1300 then returns to decision block 1302. As such, the SLA monitoring engine 1200 may monitor the performance of workloads by any LCSs provided using subsets of the resource devices 704a-704c as LCSs are created (e.g., following received workload intents) and destroyed (e.g., following the completion of workloads), and may perform any management operations that provide for the efficient use of the resource devices 704a-704c while satisfying SLAs for those workloads and/or their workload capabilities, and operate to perform the workloads in as optimal a manner as possible in light of the different workloads competing for the use of the resource devices 704a-704c.

Thus, systems and methods have been described that provide for the satisfaction of SLAs for workloads performed using distributed, shared, and dynamically-allocated resource devices in multiple resource systems. For example, the workload Service Level Agreement (SLA) satisfaction system of the present disclosure may include a resource management system that is coupled to a client device and each of a plurality of resource devices. The resource management system receives a workload intent that identifies workload capabilities of a first workload, generates a Directed Acyclic Graph (DAG) that maps the workload capabilities to a first subset of the plurality of resource devices that are configured to provide the workload capabilities and to Service Level Agreement (SLA) monitoring functionality, configures the first subset of the plurality of resource devices to perform the first workload and report SLA information according to the SLA monitoring functionality, and configures an SLA monitoring subsystem based on the SLA monitoring functionality to receive the SLA information during performance of the first workload by the first subset of the plurality of resource devices, and perform a management operation based on the SLA information. As such, distributed resource devices may be utilized to perform multiple workloads in a manner that satisfies the SLAs for those workloads.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A workload Service Level Agreement (SLA) satisfaction system, comprising:
a plurality of resource devices;
a client device; and
a resource management system that is coupled to the client device and each of the plurality of resource devices, wherein the resource management system is configured to:
receive a workload intent that identifies workload capabilities of a first workload;
generate a Directed Acyclic Graph (DAG) that maps the workload capabilities to a first subset of the plurality of resource devices that are configured to provide the workload capabilities, and to Service Level Agreement (SLA) monitoring functionality;
configure the first subset of the plurality of resource devices to perform the first workload and report SLA information according to the SLA monitoring functionality; and
configure, based on the SLA monitoring functionality, an SLA monitoring subsystem that is configured, during performance of the first workload by the first subset of the plurality of resource devices, to receive the SLA information and perform a management operation based on the SLA information.

2. The system of claim 1, wherein the first subset of the plurality of resource devices minimizes the plurality of resource devices used to perform the first workload.

3. The system of claim 1, wherein the management operations include reporting a violation of an SLA that is included in at least one of the workload capabilities.

4. The system of claim 1, wherein the management operations include:
modifying the DAG to map the workload capabilities to a second subset of the plurality of resource devices that are different than the first subset of the plurality of resource devices and that are configured to provide the workload capabilities; and
configuring the second subset of the plurality of resource devices to perform the first workload.

5. The system of claim 4, wherein the management operations include:
determining, prior to modifying the DAG and based on the SLA information, that the second subset of the plurality of resource devices are configured to satisfy at least one SLA that is included in the workload capabilities and that is not satisfied by the first subset of the plurality of resource devices.

6. The system of claim 1, wherein the management operations include modifying the performance of a second workload by at least some of the plurality of resource devices.

7. An Information Handling System (IHS), comprising:
a processing system; and
a memory system that is coupled to the processing system and that includes instructions that, when executed by the processing system, cause the processing system to provide a resource management engine that is configured to:
receive a workload intent that identifies workload capabilities of a first workload;
generate a Directed Acyclic Graph (DAG) that maps the workload capabilities to a first subset of a plurality of resource devices that are coupled to the processing system and configured to provide the workload capabilities, and to Service Level Agreement (SLA) monitoring functionality;
configure the first subset of the plurality of resource devices to perform the first workload and report SLA information according to the SLA monitoring functionality; and
configure, based on the SLA monitoring functionality, an SLA monitoring subsystem that is configured, during performance of the first workload by the first subset of the plurality of resource devices, to receive the SLA information and perform a management operation based on the SLA information.

8. The IHS of claim 7, wherein the first subset of the plurality of resource devices minimizes the plurality of resource devices used to perform the first workload.

9. The IHS of claim 7, wherein the management operations include reporting a violation of an SLA that is included in at least one of the workload capabilities.

10. The IHS of claim 7, wherein the management operations include:
modifying the DAG to map the workload capabilities to a second subset of the plurality of resource devices that are different than the first subset of the plurality of resource devices and that are configured to provide the workload capabilities; and
configuring the second subset of the plurality of resource devices to perform the first workload.

11. The IHS of claim 10, wherein the management operations include:
determining, prior to modifying the DAG and based on the SLA information, that the second subset of the plurality of resource devices are configured to satisfy at least one SLA that is included in the workload capabilities and that is not satisfied by the first subset of the plurality of resource devices.

12. The IHS of claim 7, wherein the management operations include modifying the performance of a second workload by at least some of the plurality of resource devices.

13. The IHS of claim 7, wherein the workload intent and the workload capabilities are provided via a Topology Orchestration Specification for Cloud Applications (TOSCA) subsystem.

14. A method for satisfying a Service Level Agreement (SLA) for a workload, comprising:
receiving, by a resource management system, a workload intent that identifies workload capabilities of a first workload;
generating, by the resource management system, a Directed Acyclic Graph (DAG) that maps the workload capabilities to a first subset of a plurality of resource devices that are configured to provide the workload capabilities, and to Service Level Agreement (SLA) monitoring functionality;
configuring, by the resource management system, the first subset of the plurality of resource devices to perform the first workload and report SLA information according to the SLA monitoring functionality; and
configuring, by the resource management system based on the SLA monitoring functionality, an SLA monitoring subsystem that is configured, during performance of the first workload by the first subset of the plurality of resource devices, to receive the SLA information and perform a management operation based on the SLA information.

15. The method of claim 14, wherein the first subset of the plurality of resource devices minimizes the plurality of resource devices used to perform the first workload.

16. The method of claim 14, wherein the management operations include reporting a violation of an SLA that is included in at least one of the workload capabilities.

17. The method of claim 14, wherein the management operations include:
modifying the DAG to map the workload capabilities to a second subset of the plurality of resource devices that are different than the first subset of the plurality of resource devices and that are configured to provide the workload capabilities; and
configuring the second subset of the plurality of resource devices to perform the first workload.

18. The method of claim 14, wherein the management operations include:
determining, prior to modifying the DAG and based on the SLA information, that the second subset of the plurality of resource devices are configured to satisfy at least one SLA that is included in the workload capabilities and that is not satisfied by the first subset of the plurality of resource devices.

19. The method of claim 14, wherein the management operations include modifying the performance of a second workload by at least some of the plurality of resource devices.

20. The method of claim 14, wherein the workload intent and the workload capabilities are provided via a Topology Orchestration Specification for Cloud Applications (TOSCA) subsystem.
